(19) United States
(12) Patent Application Publication
(10) Pub. No.: US 2005/0158443 A1
(43) Pub. Date: Jul. 21, 2005

(54) Beverages and their preparation

(75) Inventors: Kai Grebenkamper, Vlaardingen (NL); Reinhard Kohlus, Vlaardingen (NL); Krassimir Petkov Velikov, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 11/017,248

(22) Filed: Dec. 20, 2004

(30) Foreign Application Priority Data
Dec. 23, 2003 (GB) 0329832.0

(51) Int. Cl. A23G 9/00

(52) U.S. Cl. 426/590

(57) ABSTRACT

A process for making a powdered precursor for preparing an acidic beverage upon admixture of the powdered precursor with a liquid, the process comprising the steps: (a) preparing a first slurry comprising a protein source and a stabiliser, said first slurry having a neutral or an acidic pH; (b) adjusting the pH of the first slurry, if necessary, to a value in the range of from 2 to 6, preferably from 3.5 to 4.2; and (c) spray drying the first slurry after step (a) or step (b).

### FIELD OF THE INVENTION

The present invention relates to beverages, especially beverages having acidic pH and processes for preparing them. The beverages may be in powder form for conversion into a drink by the addition of a liquid.

### BACKGROUND OF THE INVENTION

At low pH, protein suspensions tend to coagulate and precipitate. In order to produce stable acidic foods, different stabilisers have been used to prevent coagulation and precipitation of protein particles. Without such stabiliser, unwanted effects such as phase separation, precipitation and sandiness are observed. In addition, all stabilisers increase viscosity when used, and are therefore not suited to the tastes of today's consumers who prefer low viscosity and light food textures. The use of stabilisers is disclosed in many patent documents relating to milk products. A number of modifications to give lower viscosity and prevent coagulation, precipitation and phase separation of protein particles in products have been proposed, such as use of water-soluble soybean polysaccharides as dispersing agents as described in JP-A- 57 458, but when the pH of the product approaches the neutral range the stability is often lowered, and therefore products with even higher stability have been desired. GB-A-2314564 discloses the use of beet-derived pectin for refining beverages produced by alcohol fermentation. EP-A-0958746 discloses the use beet-derived pectin incorporated into acidic protein foods as a stabiliser.

It is also known to granulate powdered soybean protein in a fluidized bed agglomerator whilst spraying-on an aqueous solution of carbohydrate, as disclosed in US-A-2002/146487 and US-A-2003/124226.

Stabilisers such as methoxy pectin (HM-pectin), sodium carboxymethylcellulose (CMC-Na), propylene glycol alginate ester (PGA), water-soluble soybean polysaccharides (SSP), and beet-derived pectin (BD-pectin) have normally been used in ready-to-drink products, either alone or in combination (including mixtures with other polysaccharides) for production of ready-to-drink acidic protein foods in order to prevent coagulation and precipitation of protein particles.

Thus, there remains a need to provide acidic beverages, which are either in liquid, drinkable form or which can be made into a drinkable composition by dispersing in a liquid, the drinkable compositions having a low viscosity, preferably in the range of 5 to 50 mPas or 5 to 60 mPas at a shear rate of either 0.1 s⁻¹ or 10 s⁻¹ beverages avoid the drawbacks of coagulation, precipitation, phase separation, etc. of protein particles in a wide acidity range. In addition, the beverages preferably have a fresh taste, do not produce sandiness or chalkiness sensation, and do not have a sticky mouth feeling.

### SUMMARY OF THE INVENTION

According to a first aspect of the invention there is provided a process for making a powdered precursor for preparing an acidic beverage upon admixture of the powdered precursor with a liquid, the process comprising the steps:
(a) preparing a first slurry comprising a protein source and a stabiliser, said first slurry having a neutral or an acidic pH;
(b) adjusting the pH of the first slurry, if necessary, to a value in the range of from 2 to 6, preferably from 3.5 to 4.2; and
(c) spray drying the first slurry after step (a) or step (b).

According to a second aspect of the invention there is an acidic beverage made by the admixture of a liquid, preferably an aqueous liquid and a powdered precursor made by the process of the first aspect of the invention. An aqueous liquid is one which contains at least some water, preferably at least 10%, more preferably at least 25%, most preferably at least 50% by weight of water. The term also includes substantially pure water such as tap water.

In a particularly preferred embodiment, the inventors have ground that the above-mentioned problems can be overcome by spray drying of solutions of plant proteins and stabilisers at acidic pH.

### DETAILED DESCRIPTION OF THE INVENTION

The beverage powder precursors must be mixed with a liquid in order to form a composition which is suitable for a consumer to drink. Any suitable liquid can be used, but preferred examples are water and juices such as citrus juices.

Preferably a second slurry is prepared comprising the protein source, a third slurry is prepared comprising the stabiliser and the second and third slurries are admixed to provide said first slurry.

If the first slurry has a pH outside the target range of from 2 -6 or outside the preferred target range of from 3.5 to 4.2, then before spray drying in step (c), in step (b) its pH is adjusted by conventional means.

The Protein Source

The protein source may comprise any specific type of protein, e.g. animal, in particular dairy protein, or plant protein. Preferably the protein source provides at least some plant protein, for example soy protein, pea protein or lupin protein, or mixtures thereof. These proteins can be intact or hydrolysed, and can be used separately or in combination with each other.

The total amount protein to be used may be generally about 0.5 to 10 wt %, preferably 0.5 to 4 wt %, and preferably around 2.7% wt (e.g. 4g in a 150g serving) with respect to the final product.

In relation to the first slurry, the amount of protein source in the second slurry could for example be from 5 to 20 wt %.

The Stabiliser

Any suitable stabiliser can be used in the present invention. However, preferred stabilisers are selected from pectins, carboxymethylcelluloses, soybean polysaccharides or glycol alginate esters or mixtures thereof.

In particular, preferred stabilisers are methoxy pectin (HM-pectin), sodium carboxymethylcellulose (CMC-Na), propylene glycol alginate ester (PGA), water-soluble soybean polysaccharides (SSP), and beet-derived pectin (BD-pectin). These may be used alone or in combination. The most preferred stabilisers are pectins.

The amount of the stabiliser to be used may be generally about 0.05-10% wt, preferably 0.05-2 wt %, e.g. 0.2-2 wt % with respect to the final beverage, but these ranges do not restrict the scope of the invention because they may vary depending on differences in the protein concentration. The weight ratio of protein:stabiliser is preferably from 5:1 to 50:1, e.g. to 12:1 more preferably from 30:1 to 10:1, e.g. 7:1 to 9:1.

The amount of stabiliser in the first slurry is preferably from 5 to 20 wt %.

With regard to the third slurry, the amount of stabiliser in the third slurry is preferably from 0.01 to 20 wt %, e.g. such as from 0.1 to 6 wt %.

Any of the stabilisers discussed above may be used in combination with one or more other auxiliary stabilisers such as locust bean gum, tamarind seed polysaccharide, gelan gum, xanthan gum, guar gum, tara gum, gum Arabic, kalaya gum, carrageenan, starches and cellulose derivates, agar or the like. In this way, it is possible to produce acidic products which are stable and have low viscosity and a light texture across a wide pH range and suitable for spray drying.

Carbohydrate

Preferably, carbohydrate is included in the first slurry, most preferably introduced via the protein source-containing second slurry. Preferred carbohydrates include sugars, starches, and maltodextrin.

Other Ingredients

The powder preferably further contains emulsifier, organic acid (such as lactic, malic or citric) and fat and is fortified with minerals, vitamins, etc. Once dispersed in the liquid such as water or juice, the drink is preferably stable against coagulation and phase separation for at least 30 minutes.

Product Form

The powdered precursor may be one adapted to make any desired acidic beverages, for example yoghurts or acidic protein drinks.

The acidic powdered beverages (or “instant protein drinks”) according to the invention are most preferably acidic protein drinks, lactic acid bacteria beverages, liquid yoghurt or acidic protein drink and can be made into drinkable compositions by adding water, citrus juices or other juices.

The Process

The protein and stabiliser can mixed in two different ways. Either (i) the pH of the first slurry can be brought to acid pH below the isoelectric point of the protein, preferably less than 3.9, the protein dispersed and mixed, the stabiliser added, mixed again and the pH adjusted, or (ii) the first slurry can be brought to an acid pH above the isoelectric point, protein can be dispersed and mixed, then further mixed with a pre-dispersed stabilised solution, then the pH is adjusted as desired.

The following two non-limiting methods illustrate these two general methods respectively:

Method A: The pH is lowered to around 2.0, then the protein is added (at around 40° C.), mixed in a high-shear mixer, the HM Pectin solution added (which has been dissolved at around 60° C. to 80° C.), carbohydrate is added followed by further mixing and then the pH is ground to 4.0. Preferably, the mixture is homogenised.

Method B: The protein is dispersed in water, mixed in a high-shear mixer, then a pectin solution (which has been dissolved at around 60° C. to 80° C.) is incorporated in this mixture, with pH around 2, sugar is added followed by further mixing and the pH is adjusted to around 4.0. Preferably the mixture is homogenised.

When a spray drying operation is used, the feed may be a stable solution of the ingredients with a dry matter content between 10 and 50%, preferably between 30 and 40% (m/m). This slurry is spray dried in a so-called spray-drier, resulting in fine particulate matter. A spray dryer is a system where the feed liquid is atomised by means of any type of atomiser, i.e. rotary, two or one phase nozzle, and subsequently dried to from particulate matter. Where the particle size is between 5 and 400 μm, eg between 5 and 100 μm. To produce a dry powder, the spray tower is preferably operated at a temperature of from 150 to 250° C., depending on the dry matter content and tower loading (mass flow ratio slurry to air). The resulting powder will be typically hydrophobic. Due to its fineness and hydrophobicity the material is typically difficult to disperse in water without lump formation. An additional agglomeration or granulation step increases the particle size of each particle. The initial particle will have a d₄,₃ average particle diameter of from 5 μm to 100 μm, for example from 5 μm to 35 μm whereas the preferred d₄,₃ average particle size ex granulator lies preferably between 50 and 600 μm, more preferably between 150 and 400 μm. This improve the dispersibility so far that it can be easily use in a powdered drink mix, where the spray-dried powder is used, in a mixture with other powders. The agglomeration preferably takes place in a fluid bed type of agglomerator, like a Fielder-Aeromatic type. The binder fluid is preferably plain water. It is advantageous to agglomerate a mixture of the spray-dried material with a carbohydrate like sucrose or maltodextrin or an easily dissolving salt. Alternatively any other type of agglomerator can be used, e.g.:
high shear mixer granulator e.g. Schugi type granulator or Loedige ploughshare type,
pressure granulators, e.g. Bepex basket extruder type granulators, or
steam granulators.

The most favourable technique is the use of a combined spray-drier/fluidised bed system, where the powder from the spray drier is directly granulated. Such a system would be for example a Fluidized Spray Dryer or a Multistage Spray Dryer form GEA Niro A/S. The agglomeration could be just due to the remaining cohesiveness of the powder due to steam treatment or water spray on, with or without addition of easily water soluble material as binder. Such material would be carbohydrates, salts or polymers known as binder.

The addition of lecithin can improve the wetability and dispersability of the powder.

The present invention will now be explained in more detail by way of the following non-limiting examples. Throughout these examples, the parts and percentages are based on weight unless otherwise specified.

### EXAMPLES

### Example 1

The composition (see Table1) of the soy protein isolate (FXP H0219D, 86.7% ex Solae), maltodextrin and water are mixed with a high-shear mixer, Silverson Batch mixer type for 15 minutes at 60° C. A second aqueous solution of citric acid (CA) at pH 2.0 and 4% HM Pectin (YM 115H ex CP Kelco) was prepared. The complete mixture is again homogenised with the high-shear mixer. The pH of said concentrate is adjusted to 3.9 by citric acid addition.

The concentrates prepared thereby have a total protein content of 6.7-17.35 wt %, a total hydrocolloid amount of 0.23 -0.79% wt and a total solid content of 20-30 wt % (Table 1).

TABLE 1

| Slurry | T1 | T2 | T4 | T5 | T6 |
|---|---|---|---|---|---|
| Solids % | 20 | 25 | 25 | 30 | 30 |
| Water % | 80.00 | 75.00 | 75.00 | 70.00 | 70.00 |
| Protein % | 6.73 | 8.21 | 14.30 | 10.04 | 9.63 |
| MD % | 11.70 | 14.29 | 14.48 | 17.35 | 16.64 |
| Pectin % | 0.23 | 0.86 | 0.87 | 0.82 | 0.79 |
| CA % | 1.35 | 1.64 | 1.33 | 1.79 | 1.72 |
| Lecithin % | 0.00 | 0.00 | 0.00 | 0.00 | 1.23 |

The resulting mixture was pumped to the nozzle of a two fluid nozzle atomiser mounted in the commercial spray-drying unit, a Niro Production Minor type. Inlet temperature was set to 200° C. Outlet temperature yield 110° C. Microcapsules with a mean size of ca. 20 μm were obtained.

The composition of the resulting powder is given in Table 2.

TABLE 2

| Powder | T1 | T2 | T4 | T5 | T6 |
|---|---|---|---|---|---|
| H₂0 % | 3.1 | 3.1 | 3.1 | 3.0 | 2.8 |
| Protein % | 32.6 | 31.9 | 32.3 | 32.5 | 31.2 |
| MD % | 56.7 | 55.4 | 56.2 | 56.2 | 53.9 |
| Pectin % | 1.1 | 3.3 | 2.8 | 2.7 | 2.6 |
| CA % | 6.5 | 6.4 | 5.2 | 5.8 | 5.6 |
| Lecithin % | 0.0 | 0.0 | 0.0 | 0.0 | 4.0 |

The viscosity was tested in a cone-plate geometry of a rotational rheometer. Temperature was set to 20° C. The data are taken from the down curve of a flow curve hysteresis. 10 1/s and 50 1/s were chosen as relevant shear rates (see table 3).

The stability of the beverages was tested by measuring the phase-separated volume in a cylinder as well as visually. When visually clear flocs were determined the system was classified as unstable (see table 3).

The surface weighted volume mean diameters D3,2 and D4,3 of the particles in the beverage were determined by laser diffraction to get a value for sandiness (see table 3).

The amount of unstable dispersed mater was measured by centrifugation of the final product for 20 minutes at 2800 g and 20° C. The percentage of the sediment (sediment/total mass×100) was measured after 5 minutes of dripping out the water (see table 3).

TABLE 3

| Powder | | T1 | T2 | T4 | T5 | T6 |
|---|---|---|---|---|---|---|
| Total solids content in final | % | 20.00% | 20.00% | 20.00% | 20.00% | 20.00% |
| product | | | | | | |
| pH | — | 3.55 | 3.61 | 3.64 | 3.67 | 3.86 |
| D3,2 wet 5 min. | micron | 8.2 | 6 | 5.4 | 5.5 | 13.46 |
| D4,3 wet 5 min. | micron | 52.2 | 32 | 13.1 | 14.5 | 21.8 |
| Phase separation 15 min. | % | 0 | 0 | 0 | 0 | 0 |
| Stable after 15 min. | | yes | yes | yes | yes | yes |
| Phase separation 45 min. | % | 0 | 0 | 0 | 0 | 0 |
| Stable after 45 min. | | yes | yes | yes | yes | yes |
| eta 10 1/sec. 5 min | mPas | 40 | 35 | 26 | 21 | 14 |
| eta 50 1/sec. 5 min | mPas | 37 | 33 | 26 | 21 | 11 |
| Centrifugation | [% w/w] | 15.2 | 10.1 | 8.5 | 6.5 | 3.6 |

Further example were prepare in the same way as described in Example 1 and they are given in Table 4. The used material was a standard spray dried skim milk powder as source for a milk protein. The soy protein originates from a soy protein isolate: FXP 219 D ex Solae, as pea protein Pisane HD NO5 ex Cosucrua was used. The stabiliser are: Blanose 7LF ex Hercules (SCMC 7), Blanose 9M31F ex Hercules (SCMC 9), SB-Pectin is a Sugar beet Pectin of type Genu beta ex CP Kelco, and the HM Pectin is a JMJ type high methoxy pectin ex CP Kelco. The used maltodextrin is a DE 12 maltodextrin ex Rouquette (Glucidex IT 12).

TABLE 4
Different proteins and stabilisers

| Example | | 2 | 3 | 4 | 5 | 6 | 7 |
|---|---|---|---|---|---|---|---|
| Type | | SCMC 7 | SCMC 7 | SCMC 9 | SCMC 7 | SB- | HM |
| | | | | | | Pectin | Pectin |
| Protein source | | soy | soy | SMP | SMP | soy | pea |
| Protein powder | SMP | 0% | 0% | 65% | 65% | 0% | 0% |
| | Soy | 30% | 30% | 0% | 0% | 22% | 22% |
| | Pea | 0% | 0% | 0% | 0% | 0% | 0% |
| Maltodextrin | MD12 | 62% | 62% | 28% | 28% | 72% | 72% |
| Citric acid | | 4.00% | 4.00% | 3.00% | 3.00% | 3.00% | 3.00% |
| Biopolymer | | 2.00% | 2.00% | 2.00% | 2.00% | 3.00% | 3.00% |
| T in | [° C.] | 159.5 | 160 | 160 | 160 | 159.5 | 160 |
| T out | [° C.] | 83.4 | 83.7 | 82.7 | 81.5 | 84.1 | 84.1 |
| Total solids content in | % | 20% | 20% | 20% | 20% | 20% | 20% |
| final product | | | | | | | |
| pH | | 4.16 | 5.6 | 5.3 | 4.66 | 3.8 | 3.5 |
| D3,2 wet 5 min. | micron | 8.1 | 5 | 8.1 | 10.1 | 7.1 | 25.6 |
| D4,3 wet 5 min. | micron | 12.4 | 12.1 | 52 | 24.3 | 14.2 | 54.6 |
| Phase separation 15 [symbol] | % | 0 | 0 | 0 | 0 | 0 | 0 |
| Stable after 15 min. | | slightly | slightly | yes | yes | yes | yes |
| | | flocculated | flocculated | | | | |
| Phase separation 45 [symbol] | % | 0 | 0 | 0 | 0 | 0 | 0 |
| Stable after 45 min. | | slightly | slightly | yes | yes | yes | yes |
| | | flocculated | flocculated | | | | |
| eta 10 1/sec. 5 min | mPas | 23 | 30 | 49 | 55 | 18 | 52 |
| eta 50 1/sec. 5 min | mPas | 13 | 28 | 52 | 43 | 16 | 49 |
| centrifugation | % | 29.6 | 22 | 13.5 | 22.3 | 16.97 | 22.9 |

Reference samples were produced for comparison to the above examples.

TABLE 5
Reference samples

| Example | | Ref 1 | Ref 2 | Ref 3 | Ref 4 | Ref 5 |
|---|---|---|---|---|---|---|
| Protein source | | Soy | Soy | SMP | SMP/ | SMP/HM- |
| | | | | | SCMC 7 | Pectin |
| Protein powder | SMP | 0.0% | 0.0% | 63.0% | 65.0% | 65.0% |
| | Soy | 28.5% | 30.0% | 0.0% | 0.0% | 0.0% |
| | Pea | 0.0% | 0.0% | 0.0% | 0.0% | 0.0% |
| Maltodextrin | IT 12 | 67.5% | 67.0% | 34.0% | 32.0% | 35.0% |
| Citric acid | | 4.0% | 3.0% | 3.0% | 3.0% | 2.0% |
| Biopolymer | | 0.0% | 0.0% | 0.0% | 2.0% | 4.0% |
| T in | [° C.] | 160.5 | 161 | 160 | 160 | 160 |
| T out | [° C.] | 83.8 | 82.8 | 85 | 83.9 | 85 |
| Total solids content in | % | 20% | 20% | 20% | 20% | 20% |
| final product | | | | | | |
| pH | | 3.8 | 5.5 | 4.5 | 5.6 | 5.2 |
| D3,2 wet 5 min. | micron | 9.5 | 5.5 | 33.7 | 0.34 | 22.1 |
| D4,3 wet 5 min. | micron | 28 | 25.5 | 69.4 | 110 | 82 |
| Phase separation 15 [symbol] | % | 3 | 0 | 37 | 0 | 5 |
| Stable after 15 min. | | strongly | slightly | strongly | yes | strongly |
| | | flocculated | flocculated | flocculated | | flocculated |
| Phase separation 45 [symbol] | % | 4 | 0.5 | 44 | 0 | 8 |
| Stable after 45 min. | | strongly | slightly | strongly | yes | strongly |
| | | flocculated | flocculated | flocculated | | flocculated |
| eta 10 1/sec. 5 min | mPas | 117 | 58 | 70 | 41 | 203 |
| eta 50 1/sec. 5 min | mPas | 58 | 29 | 35 | 40 | 356 |
| centrifugation | % | 21.3 | 36.7 | 21.7 | 4.7 | 45.2 |

Examples from agglomeration are given in table 6. A1 was agglomerated in a so-called multistage drier, where a fluid bed is integrated in the spray tower. Sample A2 and A2.2 were produced by fluid bed agglomeration of a spray-dried powder. An external fluid bed was used and a surplus of Glucidex IT 12 (ex Roquette) was used in this process. It was possible to disperse the agglomerated powder by adding it to water and by stirring the mass for 20 seconds with a spoon. This shows that the powder has good instant properties. The non-agglomerated samples (table 4, 5) showed less ideal instant properties and they were dispersed shortly by a blender type of equipment for 15 sec.

TABLE 6
Examples for agglomerated powders

| Example | | A1 | A2 | A2.2 |
|---|---|---|---|---|
| Protein source | | Soy/SMP | Soy | Soy |
| Protein powder | SMP | 15.8% | 0.0% | 0.0% |
| | Soy | 26.9% | 17.0% | 17.0% |
| | Pea | 0.0% | 0.0% | 0.0% |
| Maltodextrin | IT 12 | 49.6% | 78.8% | 78.8% |
| Citric acid | CA | 4.0% | 2.9% | 2.9% |
| Pectin | HM-Pecti [symbol] | 3.1% | 1.4% | 1.4% |
| Total solids content in | % | 20.0% | 20.0% | 40.0% |
| final product | | | | |
| pH | | 4.4 | 3.83 | 3.8 |
| D3,2 wet 5 min. | micron | 7.3 | 11 | 10.4 |
| D4,3 wet 5 min. | micron | 16.3 | 22.6 | 20.3 |
| Phase separation 15 [symbol] | % | 0 | 0 | 0 |
| Stable after 15 min. | | yes | yes | yes |
| Phase separation 45 [symbol] | % | 0 | 0 | 0 |
| Stable after 45 min. | | yes | yes | yes |
| eta 10 1/sec. 5 min | mPas | 69 | 10 | 35 |
| eta 50 1/sec. 5 min | mPas | 58 | 8 | 36 |
| centrifugation | % | 25.4 | 9.9 | 21.1 |

1. A process for making a powdered precursor for preparing an acidic beverage upon admixture of the powdered precursor with a liquid, the process comprising the steps:
(a) preparing a first slurry comprising a protein source and a stabiliser, said first slurry having a neutral or an acidic pH;
(b) adjusting the pH of the first slurry, if necessary, to a value in the range of from 2 to 6, preferably from 3.5 to 4.2; and
(c) spray drying the first slurry after step (a) or step (b).

2. The process according to claim 1, wherein a second slurry is prepared comprising the protein source, a third slurry is prepared comprising the stabiliser and the second and third slurries are then mixed to form said first slurry.

3. The process of claim 1, wherein carbohydrate is added to at least one slurry, preferably the second slurry.

4. The process of claim 1, further comprising the step of subjecting the slurry or any of the slurries, as appropriate to a heat treatment, preferably in the range of from 40° C. to 80° C.

5. The process of claim 1, further comprising the step of homogenising first slurry.

6. The process of claim 1, further comprising agglomerating the spray dried product of step (c).

7. The process of claim 1, wherein in step (a) the first slurry has a pH below the isoelectric point of the protein, preferably a pH below 3.9.

8. The process claim 1, wherein in step (a) the first slurry has a pH above the isoelectric point of the protein.

9. The process according to claim 2, wherein the stabiliser in the third slurry is neutral or is negatively charged.

10. The process of claim 1, wherein the protein source comprises a plant protein, an animal protein or mixtures thereof.

11. The process of claim 10, wherein the plant protein is selected from soy protein, pea protein or lupin protein or mixtures thereof, and/or the animal protein is dairy protein.

12. The process of claim 1, wherein the stabiliser is selected from pectins, carboxymethylcelluloses, soybean polysaccharides or glycol alginate esters or mixtures thereof.

13. The process of claim 12, wherein the stabiliser is a pectin.

14. The process of claim 2, wherein the amount of stabiliser in the third slurry is from 0.01 to 20 wt %, preferably from 0.1 to 20 wt %.

15. The process of claim 1 wherein in step (d) one or more further ingredients are added to the mixture of slurries, these ingredients preferably being selected from fat, emulsifiers and organic acids.

16. An acidic beverage made by the admixture of a liquid, preferably an aqueous liquid and a powdered precursor made by a process for making a powdered precursor for preparing an acidic beverage upon admixture of the powdered precursor with a liquid, the process comprising the steps:
(a) preparing a first slurry comprising a protein source and a stabiliser, said first slurry having a neutral or an acidic pH;
(b) adjusting the pH of the first slurry, if necessary, to a value in the range of from 2 to 6, preferably from 3.5 to 4.2; and
(c) spray drying the first slurry after step (a) or step (b).

17. The acidic beverage of claim 16, which contains stabiliser at a level of from 0.05 to 10 wt %.

18. The acidic beverage of claim 16, which contains protein at a level of from 0.5 to 10 wt %.

19. The acidic beverage of claim 16, which is in powder form and which can be made into a drink by the addition of a liquid.

20. The acidic beverage of claim 16 in admixture with a liquid, preferably an aqueous liquid.

21. The drinkable acidic beverage of claim 20, which has a viscosity of from 5 to 60 mPas, preferably from 5 to 50 mPas at a shear rate of either 0.1 s⁻¹ or 10 s⁻¹.
